(19) United States
(12) Patent Application Publication
(10) Pub. No.: US 2014/0130274 A1
(43) Pub. Date: May 15, 2014

(54) REFILL HEAD FOR AN ORAL CARE IMPLEMENT HANDLE

(71) Applicant: Joseph E. Fattori, East Sandwich, MA (US)

(72) Inventor: Joseph E. Fattori, East Sandwich, MA (US)

(73) Assignee: COLGATE-PALMOLIVE COMPANY, New York, NY (US)

(21) Appl. No.: 14/232,249

(22) PCT Filed: Feb. 3, 2012
(86) PCT No.: PCT/US2012/023766

§ 371 Date: Jan. 11, 2014

(30) Foreign Application Priority Data
Jul. 12, 2011 (US) 61506933

(51) Int. Cl. A61C 17/22; A61C 17/34

(52) U.S. Cl. CPC A61C 17/222; A61C 17/3481
USPC 15/22.1; 15/167.1

(57) ABSTRACT

A refill head for an oral care implement, such as a toothbrush, wherein the refill head utilizes a specially designed structure for coupling the refill head to an oral care implement handle that ensures proper alignment and simplifies the loading and unloading of the refill head to the oral care implement handle. In one embodiment, the refill head comprises a tubular sleeve forming a cavity and first and second upper cam surfaces that form shoulders within the cavity. The first and second upper cam surfaces are separated by first and second axial slots of different configurations that prevent loading of the refill head onto the oral care implement handle in an improper rotational orientation through interaction with first and second bosses on the oral care implement handle.

### CROSS-REFERENCE TO RLATED APPLICATIONS

This application claims the benefit of U.S. Provisional Patent Application No. 61/506,933, filed on Jul. 12, 2011, the content of which is hereby incorporated by reference in its entirety.

### FIELD OF THE INVENTION

The present invention relates generally to refill heads for oral care implements, and specifically to the coupling structure of the refill head.

### BACKGROUND OF THE INVENTION

Powered toothbrushes having replaceable heads, commonly referred to as refill heads, are known in the art. Such powered toothbrushes typically include a handle and a refill head that is detachably coupled to the handle. The replaceability of the heads in such powered toothbrushes is desirous because the handle, which includes the expensive motion-inducing circuitry and components, is expensive to manufacture and has a much longer life expectancy than do the cleaning elements, such as bristles, that are on the head. Consumers would not be willing to pay a premium to purchase such powered toothbrushes if they had to be discarded when the bristles or other cleaning elements wore out. Thus, it is now standard in the industry to provide refill heads that can be attached and detached from the handle so that worn out refill heads can be replaced as needed for the same handle.

Existing refill heads suffer from a number of deficiencies, including complexity of manufacture, the ability to improperly load the refill head to the handle, and inadequate coupling of the refill head to the handle. Thus, a need exist for a refill head having an improved coupling structure.

### BRIEF SUMMARY OF THE INVENTION

The present invention is directed to a refill head for an oral care implement, such as a toothbrush, wherein the refill head utilizes a specially designed structure for coupling the refill head to the oral care implement handle. The refill head comprises a tubular sleeve that forms a cavity and first and second upper cam surfaces that form shoulders within the cavity.

The first and second upper cam surfaces are separated by first and second axial slots of different configurations. The configurations of the first and second axial slots prevent loading of the refill head onto the oral care implement handle in an improper rotational orientation through interaction with first and second bosses on the oral care implement handle.

In one embodiment, the invention can be a toothbrush comprising: a handle comprising: a gripping portion; and a stem extending from the gripping portion, the stem extending along an axis; and first and second bosses extending radially from an outer surface of the stem, the first and second bosses arranged in a circumferentially spaced apart manner; and a refill head detachably coupled to the handle, the refill head comprising: a head portion comprising a plurality of tooth cleaning elements; a tubular sleeve coupled to the head portion, the tubular sleeve having a cavity in which the stem is disposed; and first and second upper cam surfaces that form transverse shoulders in the cavity, the first boss in surface contact with the first upper cam surface and the second boss in surface contact with the second upper cam surface to axially retain the stem within the cavity, the first and second upper cam surfaces circumferentially separated from one another by first and second axial slots, the first and second axial slots configured to: (1) allow the first boss to be axially slid through the first axial slot and the second boss to be axially slid through the second axial slot when the refill head is in a rotational orientation in which the first boss is axially aligned with the first axial slot and the second boss is axially aligned with the second axial slot; and (2) prohibit the second boss from being axially slid through the first axial slot when the refill head is in a rotational orientation in which the first boss is axially aligned with the second axial slot and the second boss is axially aligned with the first axial slot.

In another embodiment, the invention can be a refill head for a toothbrush handle comprising a gripping portion and a stem having a first boss and a second boss, the refill head comprising: a head portion comprising a plurality of tooth cleaning elements; a tubular sleeve coupled to the head portion, the tubular sleeve having a cavity for slidably receiving the stem, the cavity extending along an axis; and first and second upper cam surfaces that form transverse shoulders in the cavity, the first and second upper cam surfaces circumferentially separated from one another by first and second axial slots, the first and second axial slots configured to: (1) allow the first boss to be axially slid through the first axial slot and the second boss to be axially slid through the second axial slot when the refill head is in a rotational orientation in which the first boss is axially aligned with the first axial slot and the second boss is axially aligned with the second axial slot; and (2) prohibit the second boss from being axially slid through the first axial slot when the refill head is in a rotational orientation in which the first boss is axially aligned with the second axial slot and the second boss is axially aligned with the first axial slot.

In yet another embodiment, the invention can be a refill head for an oral care implement handle comprising a gripping portion and a stem having a first boss and a second boss, the refill head comprising: a head portion; a tubular sleeve coupled to the head portion, the tubular sleeve having a cavity for slidably receiving the stem, the cavity extending along an axis; first and second upper cam surfaces that form transverse shoulders in the cavity; and first and second axial slots, the first and second axial slots configured to: (1) allow the first boss to be axially slid through the first axial slot and the second boss to be axially slid through the second axial slot when the refill head is in a rotational orientation in which the first boss is axially aligned with the first axial slot and the second boss is axially aligned with the second axial slot; and (2) prohibit the second boss from being axially slid through the first axial slot when the refill head is in a rotational orientation in which the first boss is axially aligned with the second axial slot and the second boss is axially aligned with the first axial slot.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front view of a refill head and a toothbrush handle in alignment for detachable coupling according to one embodiment of the present invention, the wherein the refill head is in cross-section and the handle is in partial cut-away;

FIG. 2 is a longitudinal cross-sectional view of the refill head according to one embodiment of the present invention;

FIG. 3 is a left-side view of a stem of the toothbrush handle of FIG. 1 according to one embodiment of the present invention;

FIG. 4 is a right-side view of a stem of the toothbrush handle of FIG. 1 according to one embodiment of the present invention;

FIG. 5 is a front view of the refill head and the toothbrush handle of FIG. 1 detachably coupled together according to one embodiment of the present invention;

FIG. 6 is a linear map of the first and second cams of the refill head according to one embodiment of the present invention; and

FIG. 7 is bottom view of the refill head of FIG. 1.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

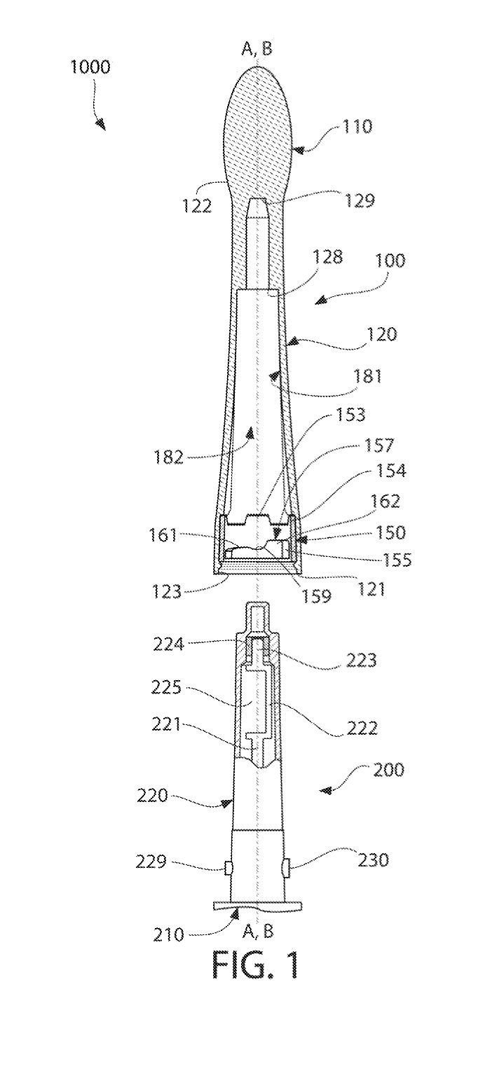

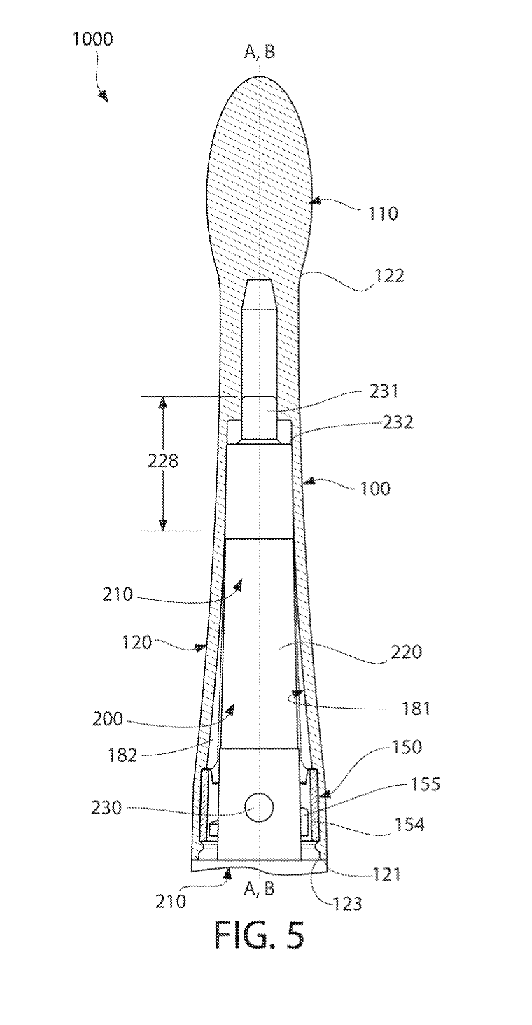

Referring to FIGS. 1 and 5 concurrently, a powered toothbrush 1000 according to one embodiment of the present invention is illustrated. The powered toothbrush 1000 generally comprises a refill head 100 and a handle 200. As discussed in greater detail below, the refill head 100 and the handle 200 are designed so that the refill head 100 can be repetitively coupled and uncoupled from the handle 200. In FIG. 1, the powered toothbrush 1000 is illustrated in a state wherein the refill head 100 is not coupled to the handle 200 but is positioned an axial alignment with the handle 200 so that such coupling can be effectuated. In FIG. 5, the powered toothbrush 1000 is illustrated in a state wherein the refill head 100 is detachably coupled to the handle 200 according to an embodiment of the present invention.

While the invention is exemplified herein as a powered toothbrush 1000, it is to be understood that the inventive concepts discussed herein can be applied to manual toothbrushes that utilize refill heads, or other manual or powered oral care implements, including without limitation tongue cleaners, water picks, interdental devices, tooth polishers and specially designed ansate implements having tooth engaging elements.

Referring now to FIGS. 1, 3 and 4 concurrently, the handle 200 will be described in greater detail. The handle 200 generally comprises a gripping portion 210 (only a small portion of which is exemplified) and a stem 220. The stem 220 extends from the gripping portion 210 along a longitudinal axis A-A.

The gripping portion 210 of the handle 200 is an elongated structure that provides the mechanism by which the user can hold and manipulate the powered toothbrush 1000 during use. The gripping portion 210 can take on a wide variety shapes, contours and configurations, none of which are limiting of the present invention. Included within the gripping portion 210 is a power source, an electric motor and electrical circuitry and components necessary to create a desired motion within the refill head 100.

The gripping portion 210 also includes the user interface that controls the various operations of the toothbrush 1000, including without limitation turning off and on, changing speeds of the motor, or other included functions. The gripping portion 210, in essence, forms a watertight housing for the aforementioned electrical circuit and mechanical components that need to be protected from moisture.

In the exemplified embodiment, the motion to be transmitted to the head portion 110 of the refill head 100 is a vibratory motion. In order to generate such vibratory motion, the handle 200 comprises a vibratory element, which in the exemplified embodiment is in the form of an eccentric 222 coupled to a drive shaft 221. A proximal portion (not illustrated) of the drive shaft 221 is operably coupled to the electric motor (not illustrated) so that the electric motor can rotate the drive shaft 221. A distal portion 223 of the drive shaft 221 is retained by an annular bearing 224 which is mounted within the stem 220. As the drive shaft 221 is rotated, the eccentric 222, due to its off-center center of gravity, generates vibrations that are transmitted to the stem 220 and to the refill head 100 (discussed in greater detail below). While the eccentric 222 is exemplified as a portion of the drive shaft 221 that is radially offset from the longitudinal axis A-A, the invention is not so limited. In other embodiments, the eccentric 222 may be an offset disc or other offset weight, as is known in the art. As can be seen in FIG. 1, the stem 220 forms a watertight housing having an internal cavity 225 in which the drive shaft 221 and eccentric 222 are housed. Additional details of a suitable vibratory producing handle, and related structure that can be incorporated into the powered toothbrush 1000 of the present invention, can be found in U.S. Patent Application Publication No. 2010/0269275, Shimoyama et al., published Oct. 28, 2010 (filed as U.S. patent application Ser. No. 12/377,355), the entirety of which is hereby incorporated by reference.

The stem 220 comprises a proximal portion 226, a middle portion 227 and a distal portion 228. The proximal portion 226 is the base portion of the stem 220 that is adjacent the gripping portion 210 of the handle 200. The distal portion 228 forms the free end of the stem 220 while the middle portion is located axially between the proximal portion 226 and the distal portion 228.

The stem 220 further comprises a first boss 229 and a second boss 230 extending radially outward from an outer surface 231 of the stem 220. The first and second bosses 229, 230 are arranged on the stem 220 in a circumferentially spaced apart manner. In the exemplified embodiment, the first and second bosses 229, 230 are approximately 180° apart. Of course, other angular degrees of separation can be utilized as desired. Moreover, in alternate embodiments, more or less than two bosses 229, 230 can be included on the stem 220.

As will be discussed in greater detail below, the first and second bosses 229, 230 have different configurations from one another so as to achieve the desired cooperation (or lack thereof) with the axial slots 151, 152 of the cam collar 150. In the exemplified embodiment, the different configuration of the first and second bosses 229, 230 is achieved by creating the first and second bosses 229, 230 to have different sizes. As exemplified, the first boss 229 has a first diameter D₁ while the second boss 230 has a second diameter D₂, wherein the second diameter D₂ is greater than the first diameter D₁. In the exemplified embodiment, both the first and second bosses 229, 230 are cylindrical pin-like elements. However, in alternate embodiments, the first and second bosses 229, 230 can have other cross-sectional shapes, including polygonal, oval, or irregular shaped. Thus, as used herein the term “diameter” is not strictly limited to circular geometries.

In alternate embodiments, the desired cooperation (or lack thereof) between the axial slots 151, 152 of the cam collar 150 and the first and second bosses 229, 230 of the stem 220 can be achieved by appropriately designing the shapes of the axial slots 151, 152 of the cam collar 150 and the first and second bosses 229, 230 of the stem 220 (this concept will become more clear from the discussion below). Thus, in one alternate embodiment, the first boss 229 will have a first shape and the second boss 230 will have a second shape that is different than the first shape. The first shape is selected so that the first boss 229 can be axially slid through the first axial slot 151 when axially aligned therewith while the second shape cannot be axially slid through the first axial slot 151 when axially aligned therewith.

The distal portion 228 of the stem 220 further comprises a plug portion 231 extending axially from a shoulder portion 232. The plug portion 231 acts as an axial alignment feature by sliding into a distal axial section 126 of the cavity 182 of the refill head 100 when the refill head 100 is being coupled to the stem 220/handle 200. The shoulder portion 232 can be used to prevent over-insertion of the stem 220 into the cavity 182 during said coupling via contact with an annular shoulder 128 formed in the inner surface 181 of the refill head 100.

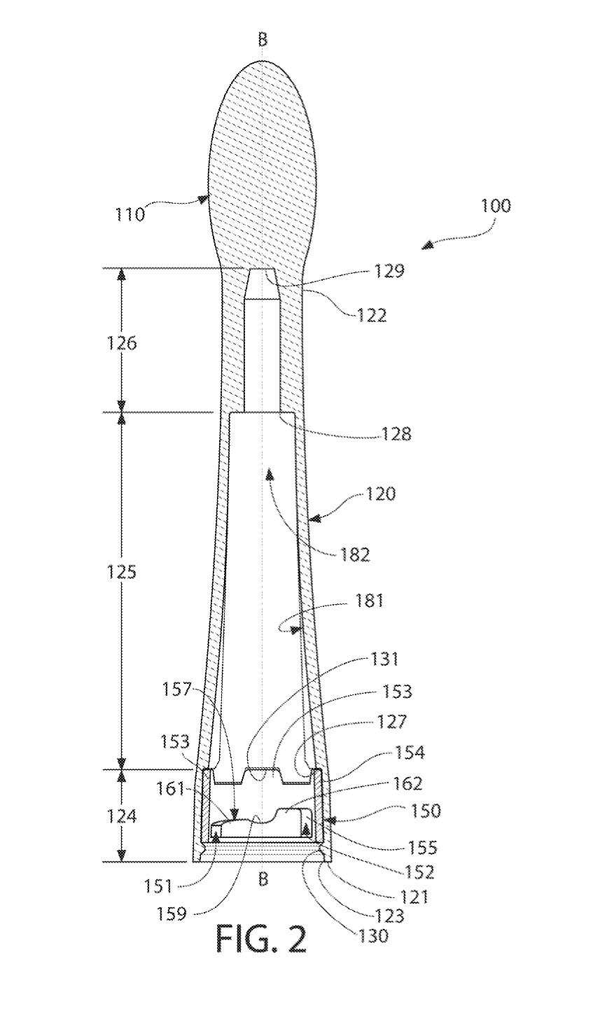

Referring now to FIGS. 2 and 6-7 concurrently, the structure of the refill head 100 will be described in greater detail. The refill head 100 generally comprises a head portion 110, a tubular sleeve 120 and an annular cam collar 150.

The tubular sleeve 120, the head portion 110 and the cam collar 150 can be formed of a material that is rigid, such as a moldable hard plastic. Suitable hard plastics include polymers and copolymers of ethylene, propylene, butadiene, vinyl compounds and polyesters such as polyethylene terephthalate. Of course, the invention is not to be so limited and other materials can be used to form the tubular sleeve 120 and head portion 110 of the refill head 100.

The tubular sleeve 120 extends along a longitudinal axis B-B from a proximal end 121 to a distal end 22. The head portion 110 is coupled to the distal end 121 of the tubular sleeve 120. In the exemplified embodiment, the tubular sleeve 120 and the head portion 110 of the refill head 100 are integrally formed as a single unitary structure using a molding, milling, machining or other suitable process. However, in other embodiments the head portion 110 and the tubular sleeve 120 of the refill head 100 may be formed as separate components which are operably connected at a later stage of the manufacturing process by any suitable technique known in the art, including without limitation thermal or ultrasonic welding, a tight-fit assembly, a coupling sleeve, threaded engagement, adhesion, or fasteners.

While not illustrated, the head portion 110 comprises a plurality of tooth cleaning elements extending from a surface thereof as is known in the art. The plurality of tooth cleaning elements are provided for cleaning and/or polishing an oral surface and/or interdental spaces. The tooth cleaning elements can be particularly suited for brushing teeth, or can be particularly suited to polish teeth instead of or in addition to cleaning teeth. As used herein, the term “tooth cleaning elements” is used in a generic sense to refer to any structure that can be used to clean, polish or wipe the teeth and/or soft oral tissue (e.g. tongue, cheek, gums, etc.) through relative surface contact. Common examples of “tooth cleaning elements” include, without limitation, bristle tufts, filament bristles, fiber bristles, nylon bristles, spiral bristles, rubber bristles, elastomeric protrusions, flexible polymer protrusions, combinations thereof and/or structures containing such materials or combinations. Suitable elastomeric materials include any biocompatible resilient material suitable for uses in an oral hygiene apparatus. To provide optimum comfort as well as cleaning benefits, the elastomeric material of the tooth or soft tissue engaging elements has a hardness property in the range of A8 to A25 Shore hardness. One suitable elastomeric material is styrene-ethylene/butylene-styrene block copolymer (SEBS) manufactured by GLS Corporation. Nevertheless, SEBS material from other manufacturers or other materials within and outside the noted hardness range could be used.

The tooth cleaning elements of the present invention can be connected to the refill head 100 in any manner known in the art. For example, staples/anchors, in-mold tufting (IMT) or anchor free tufting (AFT) could be used to mount the cleaning elements/tooth engaging elements. In AFT, a plate or membrane is secured to the brush head such as by ultrasonic welding. The bristles extend through the plate or membrane. The free ends of the bristles on one side of the plate or membrane perform the cleaning function. The ends of the bristles on the other side of the plate or membrane are melted together by heat to be anchored in place. Any suitable form of cleaning elements may be used in the broad practice of this invention. Alternatively, the bristles could be mounted to tuft blocks or sections by extending through suitable openings in the tuft blocks so that the base of the bristles is mounted within or below the tuft block.

The tubular sleeve 120 comprises an inner surface 181 that forms an internal cavity 182 that extends along the longitudinal axis B-B. The internal cavity 182 is sized and shaped to accommodate the stem 220 of the handle 200 so that the refill head 100 can be detachably coupled to the handle 200 as described below. The tubular sleeve 120 further comprises an opening 123 at the proximal end 121 that provides a passageway into the cavity 182 so that the stem 220 can be axially translated into and out of the cavity 182 via the opening 123.

The cavity 182 comprises a proximal axial section 124, a middle axial section 125, and a distal axial section 126. The proximal axial section 124 extends from the opening 123 to a first shoulder 127 formed in the inner surface 181. The proximal axial section 124 has a substantially constant transverse cross-sectional area. The middle axial section 125 extends from the first shoulder 127 to a second shoulder 128 formed in the inner surface 181. The middle axial section 125 has a tapered transverse cross-sectional area along its length moving from the first shoulder 127 to the second shoulder 128. The distal axial section 126 extends from the second annular shoulder 128 to an end wall 129. The distal axial section 126 has a reduced cross-sectional area in comparison to the middle axial section 126, even at the middle axial section's 125 smallest transverse cross-sectional area.

As mentioned above, the refill head 100 further comprises a cam collar 150. The cam collar 150 is disposed within the cavity 182 and coupled to the tubular sleeve 120. More specifically, the cam collar 150 is disposed within the proximal axial section 124 of the internal cavity 182. The cam collar 150 is coupled to the tubular sleeve 120 so as to be non-rotatable with respect to the tubular sleeve 120. In the exemplified embodiment, the axial position of the cam collar 150 within the cavity 182 of the tubular sleeve 120 is achieved by a combination of contact with the first annular shoulder 127 and an annular retaining flange 130 that protrudes radially inward from the inner surface 181. Thus, the first annular shoulder 127 prevents axial movement of the cam collar 150 relative to the tubular sleeve 120 in a first axial direction while the annular retaining flange 130 prevents axial movement of the cam collar 150 relative to the tubular sleeve 120 in a second axial direction (opposite the first axial direction). Rotational movement between the cam collar 150 and the tubular sleeve 120 is prohibited by interlock tabs 153 of the cam collar 150 that extend into axially extending slots 131 formed into the first annular shoulder 127 of the inner surface 181 of the tubular sleeve 120.

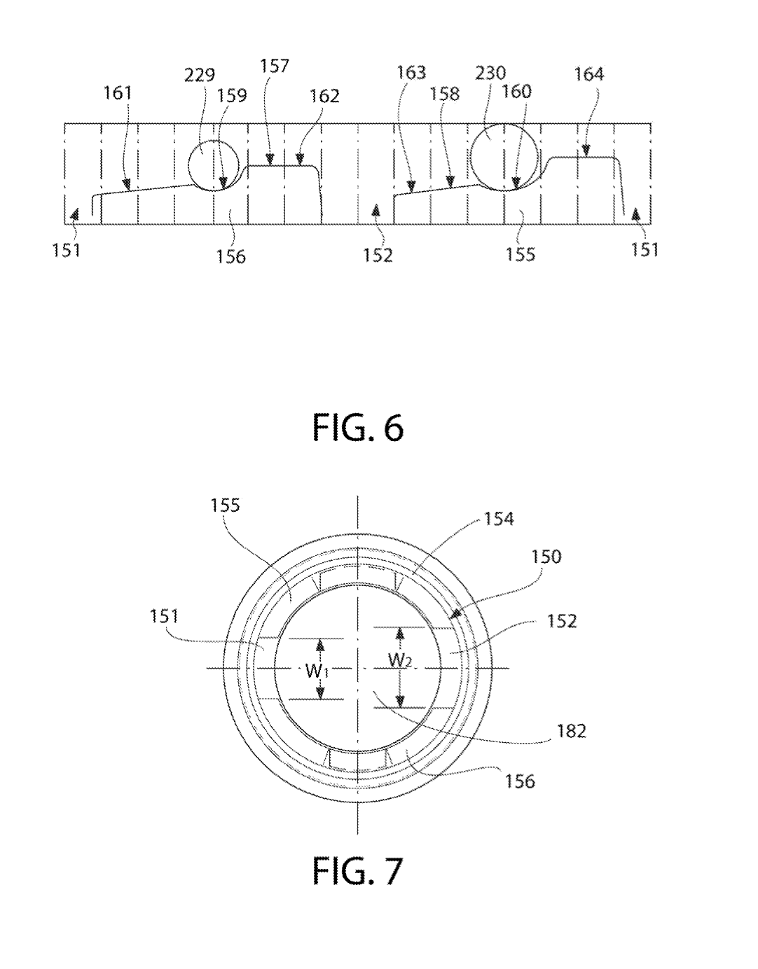

In the exemplified embodiment, the cam collar comprises an annular outer wall 154 and a first inner step 155 and a second inner step 156. The first inner step 155 comprises a first upper cam surface 157 while the second inner step 156 comprises a second upper cam surface 158. The first and second upper cam surfaces 157, 158 form transverse shoulders in the cavity 182. When the powered toothbrush 1000 is properly assembled and the refill head 100 is detachably coupled to the handle 200, the first boss 229 of the stem 120 is in surface contact with the first upper cam surface 157 and the second boss 230 in surface contact with the second upper cam surface 158 (as shown in FIG. 6) to axially retain the stem 220 within the cavity 182 to maintain the detachable coupling.

The first and second steps 155, 156, and thus the first and second upper cam surfaces 157, 158, are circumferentially separated from one another by first and second axial slots 151, 152. The first upper cam surface 157 comprises a first depression 159 in which the first boss 229 nests when the refill head 100 is detachably coupled to the handle 200. Similarly, the second upper cam surface 158 comprises a second depression 160 in which the second boss 230 nests when the refill head 100 is detachably coupled to the handle 200.

The first upper cam surface 157 also comprises a first ramp portion 161 and a first stopper portion 162. The first ramp portion 161 extends from the first axial slot 151 to the first depression 159 and is configured to allow the first boss 229 to ride along the first upper cam surface 157 from the first axial slot 151 and the first depression 159. On the other hand, the first stopper portion 162 is located between the first depression 159 and the second axial slot 152 and is configured to prohibit the first boss 229 from being rotated from the first depression 129 into axial alignment with the second axial slot 152. Similarly, the second upper cam surface 158 comprises a second ramp portion 163 and a second stopper portion 164. The second ramp portion 163 extends from the second axial slot 152 to the second depression 160 and is configured to allow the second boss 230 to ride along the second upper cam surface 158 from the second axial slot 152 to the second depression 160. To the contrary, the second stopper portion 164 is located between the second depression 160 and the first axial slot 151 and is configured to prohibit the second boss 230 from being rotated from the second depression 160 into axial alignment with the first axial slot 151.

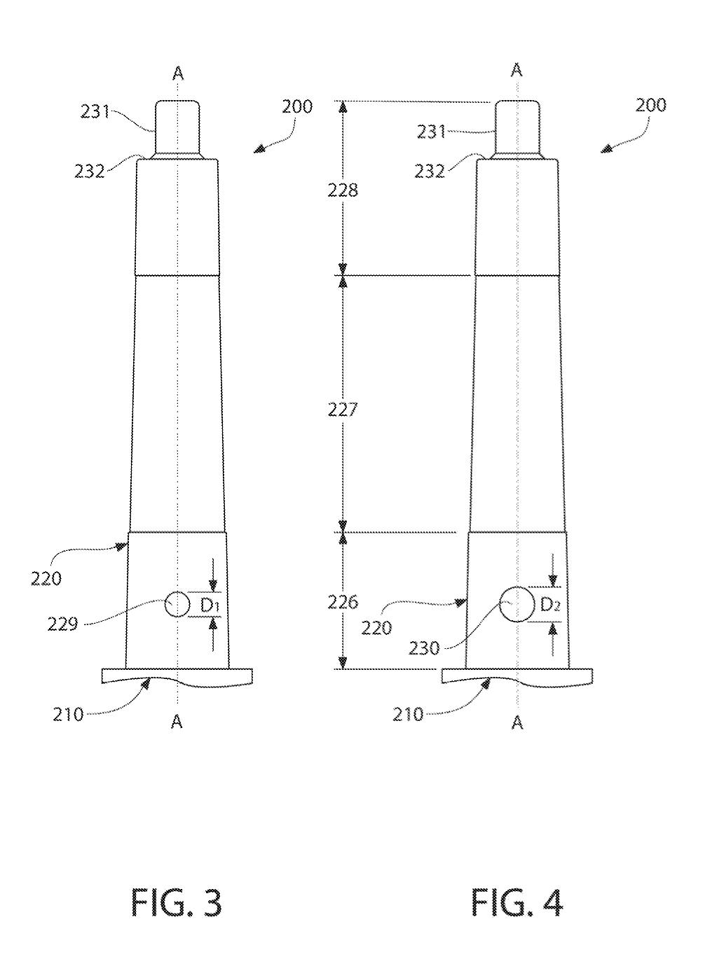

Referring now to FIGS. 3-5 and 7 concurrently, the first and second axial slots 151, 152 are configured to: (1) allow the first boss 229 to be axially slid through the first axial slot 151 and the second boss 230 to be axially slid through the second axial slot 152 when the refill head 200 is in a rotational orientation in which the first boss 229 is axially aligned with the first axial slot 151 and the second boss 230 is axially aligned with the second axial slot 152; and (2) prohibit the second boss 230 from being axially slid through the first axial slot 151 when the refill head 200 is in a rotational orientation in which the first boss 229 is axially aligned with the second axial slot 152 and the second boss 230 is axially aligned with the first axial slot 151.

In the exemplified embodiment, the second boss 230 is prohibited from being axially slid through the first axial slot 151 due to the second boss 230 being too large. Specifically, the first axial slot has a first width W₁ and the second axial slot 152 has a second width W₂. The first width W₁ is greater than or equal to the first diameter D₁ and less than the second diameter D₂. The second width W₂, on the other hand, is greater than or equal to the second diameter D₂ (and thus also greater than the first diameter D₁). As a result, the second boss 230 can be axially translated through the second axial slot 152 but is too large to be axially translated through the first axial slot 151. Thus, in order for the stem 220 of the handle 200 to be inserted into the cavity 182 of the refill head 200, the refill head must be put in a rotational orientation in which the which the first boss 229 is axially aligned with the first axial slot 151 and the second boss 230 is axially aligned with the second axial slot 152. Once this rotational orientation is achieved, the stem 220 is inserted into the cavity 182 until the first and second bosses 229, 230 pass through the first and second axial slots 151, 152 respectively. Once the first and second bosses 229, 230 have passed through the first and second axial slots 151, 152, the refill head 200 is rotated (clockwise 90 degrees) relative to the handle 200 so that the first and second bosses 229, 230 ride along the ramp portions 161, 163 of the first and second upper cam surfaces 157, 158 until they nest in the first and second depressions 159, 160 respectively. As the first and second bosses 229, 230 ride up the ramp portions 161, 163, the fit between the first and second bosses 229, 230 and the first and second upper cam surfaces 157, 158 is tightened. The first and second bosses 229, 230 then fall into the first and second depressions 159, 160, achieving a more relaxed state between the first and second bosses 229, 230 and the first and second upper cam surfaces 157, 158. The first and second depressions 159, 160 retain the first and second bosses 229, 230 in contact with the first and second upper cam surfaces 157, 158. This mating can be further enhanced by the incorporation of a resilient gasket that provides an axial force that further forces the first and second bosses 229, 230 into the first and second depressions 159, 160 (not illustrated). The stopper portions 162, 164 prevent over rotation.

When a user wants to remove the refill head 100 from the handle 200, the user rotates the refill head 100 relative to the handle 200 in the opposite rotational direction (i.e., counterclockwise 90 degrees) until the first and second bosses 229, 230 are forced from the first and second depressions 159, 160 and slide down the ramp portions 161, 163 of the first and second upper cam surfaces 157, 158. This rotation continues until the first and second bosses 229, 230 come back into axial alignment with the first and second axial slots 151, 52 respectively. At this time, the stem 220 can be axially withdrawn from the cavity 182 of the refill head 100.

Furthermore, when the refill head 100 is detachably coupled to the handle 200 as described above, the first and second supper cam surfaces 157, 158 are located within the proximal axial section 124 of the cavity 182. Moreover, only the outer surface of the distal portion 228 of the stem 220 is in intimate surface contact with the inner surface 181 of the tubular sleeve 120. Thus, vibrations generated by the eccentric 223 in the stem 220 are more effectively transmitted to the head portion 210 of the refill head 200. It is may be advantageous to minimize vibration below the distal portion 228 so that vibration is not transmitted to the handle 200.

The first and second bosses 229, 230 are integrally molded to the stem 220 in the exemplified embodiment. Further, while the first and second upper cam surfaces 157, 158 are located on the cam collar 150 in the exemplified embodiment, the first and second upper cam surfaces 157, 158 could be formed integrally into the tubular sleeve 120.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

While the foregoing description and drawings represent the exemplary embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed is:

1. A toothbrush comprising:
a handle comprising:
a gripping portion; and
a stem extending from the gripping portion, the stem extending along an axis; and
first and second bosses extending radially from an outer surface of the stem, the first and second bosses arranged in a circumferentially spaced apart manner; and
a refill head detachably coupled to the handle, the refill head comprising:
a head portion comprising a plurality of tooth cleaning elements;
a tubular sleeve coupled to the head portion, the tubular sleeve having a cavity in which the stem is disposed; and
first and second upper cam surfaces that form transverse shoulders in the cavity, the first boss in surface contact with the first upper cam surface and the second boss in surface contact with the second upper cam surface to axially retain the stem within the cavity, the first and second upper cam surfaces circumferentially separated from one another by first and second axial slots, the first and second axial slots configured to: (1) allow the first boss to be axially slid through the first axial slot and the second boss to be axially slid through the second axial slot when the refill head is in a rotational orientation in which the first boss is axially aligned with the first axial slot and the second boss is axially aligned with the second axial slot; and (2) prohibit the second boss from being axially slid through the first axial slot when the refill head is in a rotational orientation in which the first boss is axially aligned with the second axial slot and the second boss is axially aligned with the first axial slot.

2. The toothbrush according to claim 1 wherein the first upper cam surface comprises a first depression, the first boss nesting in the first depression, and wherein the second upper cam surface comprises a second depression, the second boss nesting in the second depression.

3. The toothbrush according to claim 2 wherein the first upper cam surface comprises a first ramp portion and a first stopper portion, the first ramp portion extending from the first axial slot to the first depression and configured to allow the first boss to be rotated between the first axial slot and the first depression, the first stopper portion located between the first depression and the second axial slot and configured to prohibit the first boss from being rotated from the first depression into axial alignment with the second axial slot, and wherein the second upper cam surface comprises a second ramp portion and a second stopper portion, the second ramp portion extending from the second axial slot to the second depression and configured to allow the second boss to be rotated between the second axial slot and the second depression, the second stopper portion located between the second depression and the first axial slot and configured to prohibit the second boss from being rotated from the second depression into axial alignment with the first axial slot.

4. The toothbrush according to any one of claims 1 to 3 wherein the first boss has a first diameter and the second boss has a second diameter that is greater than the first diameter, and wherein the first axial slot has a first width that is greater than or equal to the first diameter and less than the second diameter, and wherein the second axial slot has a second width that is greater than or equal to the second diameter.

5. The toothbrush according to any one of claims 1 to 3 wherein the first boss has a first shape and the second boss has a second shape, wherein the first shape can be axially slid through the first axial slot when axially aligned and the second shape cannot be axially slid through the first axial slot when axially aligned.

6. The toothbrush according to any one of claims 1 to 5 wherein the refill head further comprises a cam collar disposed within the cavity, the cam collar comprising the first and second upper cam surfaces.

7. The toothbrush according to claim 6 wherein the cam collar is axially retained within the cavity of the tubular sleeve by a retaining flange protruding from an inner surface of the tubular sleeve and rotationally retained via interlock tabs of the cam collar that extend into slots on the inner surface of the tubular sleeve.

8. The toothbrush according to any one of claims 1 to 5 wherein the first and second upper cam surfaces are formed integrally into the tubular sleeve.

9. The toothbrush according to any one of claims 1 to 8 wherein the first and second bosses are located on a base portion of the stem and the first and second upper cam surfaces are located in a proximal axial section of the cavity.

10. The toothbrush according to any one of claims 1 to 9 wherein the cavity of the tubular sleeve comprises a middle axial section that has a tapered transverse cross-sectional area.

11. The toothbrush according to any one of claims 1 to 10 wherein the handle comprises a power source and a vibratory element operably coupled to the power source.

12. The toothbrush according to claim 11 wherein the vibratory element is located within the stem.

13. The toothbrush according to claim 12 wherein only a distal section of the outer surface of the stem is in surface contact with an inner surface of the tubular sleeve.

14. The toothbrush according to any one of claims 1 to 13 wherein the cavity comprises a proximal axial section, a middle axial section, and a distal axial section, the first and second supper cam surfaces located within the proximal axial section, the stem comprising an alignment plug extending from a distal end of the stem that extends into the distal axial section, and wherein the middle axial section tapers from the proximal section to the distal section.

15. A refill head for a toothbrush handle comprising a gripping portion and a stem having a first boss and a second boss, the refill head comprising:
a head portion comprising a plurality of tooth cleaning elements;
a tubular sleeve coupled to the head portion, the tubular sleeve having a cavity for slidably receiving the stem, the cavity extending along an axis; and
first and second upper cam surfaces that form transverse shoulders in the cavity, the first and second upper cam surfaces circumferentially separated from one another by first and second axial slots, the first and second axial slots configured to: (1) allow the first boss to be axially slid through the first axial slot and the second boss to be axially slid through the second axial slot when the refill head is in a rotational orientation in which the first boss is axially aligned with the first axial slot and the second boss is axially aligned with the second axial slot; and (2) prohibit the second boss from being axially slid through the first axial slot when the refill head is in a rotational orientation in which the first boss is axially aligned with the second axial slot and the second boss is axially aligned with the first axial slot.

16. The refill head according to claim 15 wherein the first upper cam surface comprises a first depression for nesting the first boss, and wherein the second upper cam surface comprises a second depression for nesting the second boss.

17. The refill head according to claim 16 wherein the first upper cam surface comprises a first ramp portion and a first stopper portion, the first ramp portion extending from the first axial slot to the first depression and configured to allow the first boss to be rotated between the first axial slot and the first depression, the first stopper portion located between the first depression and the second axial slot and configured to prohibit the first boss from being rotated from the first depression into axial alignment with the second axial slot, and wherein the second upper cam surface comprises a second ramp portion and a second stopper portion, the second ramp portion extending from the second axial slot to the second depression and configured to allow the second boss to be rotated between the second axial slot and the second depression, the second stopper portion located between the second depression and the first axial slot and configured to prohibit the second boss from being rotated from the second depression into axial alignment with the first axial slot.

18. The refill head according to any one of claims 15 to 17 wherein the first boss has a first diameter and the second boss has a second diameter that is greater than the first diameter, and wherein the first axial slot has a first width that is greater than or equal to the first diameter and less than the second diameter, and wherein the second axial slot has a second width that is greater than or equal to the second diameter.

19. The refill head according to any one of claims 15 to 17 wherein the first boss has a first shape and the second boss has a second shape, wherein the first shape can be axially slid through the first axial slot when axially aligned and the second shape cannot be axially slid through the first axial slot when axially aligned.

20. The refill head according to any one of claims 15 to 19 wherein the refill head further comprises a cam collar disposed within the cavity, the cam collar comprising the first and second upper cam surfaces.

21. The refill head according to claim 20 wherein the cam collar is axially retained within the cavity of the tubular sleeve by a retaining flange protruding from an inner surface of the tubular sleeve and rotationally retained via interlock tabs of the cam collar that extend into slots on the inner surface of the tubular sleeve.

22. The refill head according to any one of claims 15 to 19 wherein the first and second upper cam surfaces are formed integrally into the tubular sleeve.

23. The refill head according to any one of claims 15 to 22 wherein the cavity comprises a proximal axial section, a middle axial section, and a distal axial section, the first and second supper cam surfaces located within the proximal axial section, the stem comprising an alignment plug extending from a distal end of the stem that extends into the distal axial section, and wherein the middle axial section is tapers from the proximal section to the distal section.

24. A refill head for an oral care implement handle comprising a gripping portion and a stem having a first boss and a second boss, the refill head comprising:
a head portion;
a tubular sleeve coupled to the head portion, the tubular sleeve having a cavity for slidably receiving the stem, the cavity extending along an axis;
first and second upper cam surfaces that form transverse shoulders in the cavity; and
first and second axial slots, the first and second axial slots configured to: (1) allow the first boss to be axially slid through the first axial slot and the second boss to be axially slid through the second axial slot when the refill head is in a rotational orientation in which the first boss is axially aligned with the first axial slot and the second boss is axially aligned with the second axial slot; and (2) prohibit the second boss from being axially slid through the first axial slot when the refill head is in a rotational orientation in which the first boss is axially aligned with the second axial slot and the second boss is axially aligned with the first axial slot.
